(19) United States
(12) Patent Application Publication
(10) Pub. No.: US 2004/0184887 A1
(43) Pub. Date: Sep. 23, 2004

(54) Methods and compositions for reducing dust and erosion of earth surfaces

(76) Inventor: Boyd J. Wathen, Lehi, UT (US)

Correspondence Address: MALLINCKRODT & MALLINCKRODT, 10 EXCHANGE PLACE, SUITE 510, SALT LAKE CITY, UT, 84111, US

(21) Appl. No.: 10/817,015

(22) Filed: Apr. 1, 2004

Related U.S. Application Data
(63) Continuation-in-part of application No. 10/234,420, filed on Sep. 3, 2002, now Pat. No. 6,729,805.
Application No. 10/234,420 is a continuation-in-part of application No. 09/693,671, filed on Oct. 20, 2000, now Pat. No. 6,443,661.

(51) Int. Cl. C09K 17/00

(52) U.S. Cl. 405/264

(57) ABSTRACT

Dust from and erosion of earth surfaces is controlled by the application of a fatty acid containing material such as used vegetable oil, animal renderings, or a combination thereof such as Yellow Grease to the surface and allowing the surface to harden and dry. A mixture can be made using water, sodium hydroxide or ammonia, and fatty acid containing material that can be applied to a surface at any temperature above the composition's freezing point. The added base promotes mixing of the fatty acid containing material with the water and keeps the water and fatty acid containing material from separating so the composition can be stored at ambient temperatures and transported by uninsulated trucks. Sodium hydroxide works better than ammonia as it does not migrate as much in the mixture. Additionally, both ammonia and sodium hydroxide reduce the odors associated with fatty acid containing material reducing the need for a deodorizing agent.

### RELATED APPLICATION

This is a continuation-in-part of copending application Ser. No. 10/234,420, filed Sep. 3, 2002, which is a continuation-in-part of application Ser. No. 09/693,671, filed Oct. 20, 2000, now U.S. Pat. No. 6,443,661.

### BACKGROUND OF THE INVENTION

1. Field

The invention is in the fields of methods and compositions for treating earth surfaces, such as dirt and gravel roads and parking lots, to reduce dust from and erosion of such surfaces.

2. State of the Art

Dust control on exposed earth surfaces is a continuing problem. Surfaces such as dirt roads and dirt parking lots generate substantial dust when driven over by a vehicle and can generate dust in windy weather conditions. Erosion from vehicle use and from weather conditions, such as rain, snow, or wind, also are problems for such surfaces. Surfaces such as construction sites and tailing disposal sites have similar problems, particularly in windy conditions.

There are various prior art ways of dealing with the dust problems. One way is to spray water onto the problem earth surfaces to eliminate dust. However, this is very wasteful of the water used and is labor intensive as the surface has to be maintained in a damp condition and damp surfaces dry quickly in many areas.

In some instances, petroleum products, such as diesel fuel, have been used to spread on earth surfaces to reduce dust and erosion. However, such products have been found to cause contamination of water supplies so is now outlawed in most areas. Chemicals such as magnesium chloride, re-claimed asphaltic materials, resins, lignins, lignin sulfonates, lecithin and its derivatives, and various other materials have and are being used in various circumstances, but have associated problems of contamination, only short term effectiveness because it is washed away with rain or is worn away through use, questionable effectiveness, or expense.

Vegetable oil has been tried but has similar problems to other prior art materials in that it is easily washed away by water so is effective after application only until the next rain.

### SUMMARY OF THE INVENTION

According to the invention, it has been found that a fatty acid containing grease or oil, referred to herein as a fatty acid containing material, such as rendered grease and/or used vegetable oil, or mixture of the two, creates a long lasting and cost effective material to apply to earth surfaces to reduce dust from and erosion of such surfaces. While vegetable oil is only temporarily effective for dust control because it is easily washed away by water so is easily washed away by rain, used vegetable oil and rendered animal grease, or mixtures thereof, which contain fatty acids and surprisingly do not wash away with water, are very effective for not only long lasting dust control, but erosion control also. It has been found that such product appears to bind to and penetrate into the top layer of earth forming the surface and binds the particles forming the surface and top layer together to form a dust resistant and water repellent, relatively hard surface that appears to last indefinitely.

With the previous embodiments of my invention, when the fatty acid containing material was mixed with water, it was indicated that the fatty acid containing material needed to be heated to around 130° F. in order to mix with water and be sprayed on the ground. Also, when the fatty acid containing material alone was applied to the ground, it was indicated that the fatty acid containing material should be at least about 85° F. with a surface temperature of a least about 90° F. and an air temperature of at least about 60° F. and preferably about 80° F., see my previous patent application, now U.S. Pat. No. 6,443,661, and co-pending application Ser. No. 10/234,420, filed Sep. 3, 2002, both incorporated herein by reference. I have now found that mixing the fatty acid containing material and water at higher temperatures is unnecessary if a mixing aid of either sodium hydroxide or ammonia is mixed with the water or fatty acid containing material when the two are mixed. The addition of either sodium hydroxide or ammonia causes the fatty acid containing material to dissolve into the water without additional heating and the mixture is sprayable without additional heating. This allows components to be mixed and the mixtures to go from the storage tank directly to the spray site on non-insulated trucks. Sodium hydroxide is preferred over ammonia as sodium hydroxide keeps the fatty acid containing material in suspension in the water for about 2 months. Ammonia allows migration and separating of the fatty acid containing material from the water more quickly. Once separation occurs, the mixture must be remixed before being sprayed onto a surface. However, this remixing can easily be done without addition of heat.

The fatty acid containing material may come from various sources. Used vegetable oil may come from sources such as fast food outlets where it has been used for cooking food such as french fries or from industries such as potato chip or other snack food factories. The rendered grease will generally come from an animal rendering plant, and may be tallow or similar products. The presently preferred fatty acid containing material is a mixture of used vegetable oil and animal fat available from animal rendering plants and referred to as Yellow Grease. Most animal rendering plants collect used vegetable oil and mix it with animal fat to create the Yellow Grease which is used on or as animal feed.

The described fatty acid containing material generally has an unpleasant odor. Therefore, when using the mixture of fatty acid containing material of my referenced patent and application, it is generally preferred to deodorize the mixture. A masking scent can be added to the mixture before it is applied to the surface. It had been found that when a lignin is used in the emulsion or semi-emulsion, see my referenced application Ser. No. 10/234,420, a masking scent is not necessary as the lignin masks the odor. It has now been found that the addition of sodium hydroxide or ammonia reduces the odor and generally eliminates the need for a deodorizing material. Thus, although deodorizers may still be used, the sodium hydroxide or ammonia either generally eliminates, or at least reduces, the amount of deodorizer needed.

While the fatty acid containing material and mixtures of fatty acid containing material and water of my prior patent and application usually need to be at least about 85° F. when applied, by using the sodium hydroxide or ammonia to facilitate the mixing of the fatty acid containing material and water, the spraying temperature restraints are relaxed and spraying can be done at almost any temperature above the mixture's solidification point. Tests have shown that spraying may be done at temperatures as low as about 40° F.

Sodium hydroxide and ammonia help water mix with the fatty acid containing material so well that a water-base mixture of the sodium hydroxide or ammonia can be added to the tank of a spray truck and the fatty acid containing material added later without any outside mixing. Any required mixing of the components can occur naturally in the truck on the way to the spray site. Prior to this discovery, mixing had to take place in advance of application. The mixing had to occur before leaving the storage site in a tank or drum, or take place in the tank of a truck which applied the material with a spray bar, or mixed as the ingredients were pumped together from separate tanks for application through a spray bar or nozzle. Pre-mixing and storing can be easily done with the present mixture. Use of the sodium hydroxide allows the mixture to be stored without separation for about two months, use of ammonia allows storage without separation for at least several weeks.

The sodium hydroxide or ammonia is usually mixed with the water prior to adding the fatty acid containing material. The sodium hydroxide will generally be in the form of an aqueous solution of 50% sodium hydroxide and 50% water, which is then added to the water. The fatty acid containing material is then added to the water-sodium hydroxide mixture. Generally an amount of the sodium hydroxide solution to make up between about 0.75% to about 1% by weight of the finished composition is added to the water, although it could also be added as the fatty acid containing material and water are mixed. This means that the sodium hydroxide makes up between about 0.37% and about 0.50% by weight of the finished composition. Ammonia is generally added as a 5% aqueous solution and is added in an amount so that the 5% aqueous solution makes up at least about 4%, and preferably about 5% of the finished composition. In the preferred method of mixing, the sodium hydroxide or ammonia solution is added to the water. Fatty acid containing material is then added to the water-sodium hydroxide or ammonia mixture in an amount to make up between about 5% to about 95% fatty acid containing material. The percent of fatty acid containing material in the composition affects the minimum temperature at which the composition can be applied to the surface to be treated. The more fatty acid containing material in the composition, the higher the solidification point of the composition. The mixture must be liquid for spraying. Lower levels of fatty acid containing material, however, mean more or faster separation of the fatty acid containing material and water, although even the separation at very low levels of fatty acid containing material is not large.

The fatty acid containing material should be at a temperature above its fudge point for mixing with the water-sodium hydroxide or ammonia mixture. This will usually mean that the fatty acid containing material be at a temperature of about 68° F. to about 74° F. or above for mixing.

The mixture may be sprayed onto the surface or poured onto the surface and is absorbed into the surface where it has been found to bind surface particles to form a relatively hard surface thereby reducing dust and erosion of the surface. Because no additional heat is required to mix the substances in the presence of sodium hydroxide or ammonia, an uninsulated water truck can be used to transport and spray the composition onto the surface to be treated in colder climates over a much longer portion of the year.

It has also been found that the upper about one inch of the surface to be treated may be broken up as with a harrow device prior to application of the composition of the invention, the composition applied, and the surface rolled to provide almost immediate penetration of the composition into the surface. It has been found that after rolling, traffic can immediately return to the treated surface.

### DETAILED DESCRIPTION OF THE ILLUSTRATED EMBODIMENT

The invention is a composition or product to be applied to an earth surface to reduce the dust from the earth surface and to reduce the erosion of the earth surface. The invention also includes the method of reducing the dust from and the erosion of an earth surface by applying the composition or product of the invention to the earth surface. The product of the invention is a composition of fatty acid containing material, water, and a mixing aid of either sodium hydroxide or ammonia. The method is the application of the product to the surface to be treated. It has been found that the mixing and spraying of a fatty acid containing material and water can be done at any temperature above the solidification temperature of the mixture if sodium hydroxide or ammonia is present in the mixture. Adding sodium hydroxide or ammonia to the mixture when mixing the fatty acid containing material and water allows the mixture to be stored at any temperature where the mixture is above the mixture solidification point, usually above about 40° F., to be transported in non-insulated trucks, and to be applied to a surface to be treated at any ambient temperature where the mixture remains above the mixture solidification point when applied and absorbed into the surface.

The fatty acid containing material used in the product of the invention is a grease or oil which contains fatty acid. The grease or oil is nonpetroleum based and generally will be an animal grease or used vegetable oil. The grease generally will be a rendered animal product from an animal rending plant such as tallow, or similar product. The oil will generally be used vegetable oil or similar product. Such used oil can be obtained from fast food outlets, restaurants, or some food manufacturing plants. Generally, animal rendering plants will collect used vegetable oil and mix it with animal grease to form a mixture of both vegetable oil and animal grease, generally referred to as Yellow Grease. While Yellow Grease can have various compositions, it has been found that all Yellow Greases and similar products experimented with by the inventor are satisfactory.

The fatty acid containing material as described above usually has an unpleasant odor. It is generally preferred that it be deodorized before use. Deodorizing can be achieved by the addition of a deodorizing agent such as a fragrance to the fatty acid containing material or by the addition of a lignin to the composition as described in my referenced prior patent and copending application. It has been found, however, that the addition of the sodium hydroxide or ammonia to the composition not only allows easy mixing of the fatty acid containing material and the water, but also reduces or eliminates the unpleasant odor of the fatty acid containing material in the composition. Either the sodium hydroxide or ammonia will mix immediately into the fatty acid containing material and reduce the smell, eliminating or reducing the need for a deodorizing agent.

In the currently preferred method of mixing the composition, a fifty-fifty aqueous solution of sodium hydroxide and water is mixed with the water to form a sodium hydroxide-water mixture. The fatty acid containing material is then added to the sodium hydroxide-water mixture to form the composition of the invention. If ammonia is used, a five percent aqueous solution of ammonia and water is mixed with the water to form an ammonia-water mixture. The fatty acid containing material is then added to the ammonia-water mixture to form the composition of the invention. The fatty acid containing material is added to the sodium hydroxide-water mixture or the ammonia-water mixture in an amount to form a composition that is between about 5% and about 95% fatty acid containing material. The fatty acid containing material should be at a temperature above its fudge point, usually above about 68° F. to about 74° F., when added to the sodium hydroxide-water mixture or the ammonia-water mixture and ideally is heated to between about about 72° F. and about 100° F. prior to mixing. The higher the percent of fatty acid containing material in the mixture, the thicker the composition will be. A mixture of between about 5% and about 50% yellow grease will have the consistency of milk. The water used may be at ambient temperature or may also be heated. The pH of the resulting water-fatty acid containing material mixture is around 7 compared to yellow grease's starting pH of around 5. When sodium hydroxide is used, the solution of sodium hydroxide and water preferably makes up between about 0.75% to about 1% by weight of the finished composition. This means that the sodium hydroxide makes up between about 0.37% and about 0.50% by weight of the finished composition. When ammonia is used, the solution of ammonia and water preferably makes up at least about 4% of the finished composition, and preferably at least about 5% of the finished composition. This means that the ammonia makes up at least about 0.20% by weight of the finished composition, and preferably at least about 0.25% by weight of the finished composition.

It has been found that with the addition of the sodium hydroxide or ammonia the mixing of the water and fatty acid containing material takes place substantially immediately. No special mixing equipment is needed. The fatty acid containing material and water can each be added to a truck tank without any prior mixing. Driving the truck to the spray site provides enough disturbance to mix the components adequately for spraying.

A sodium hydroxide containing mixture can be stored for up to about two months without separation occurring. An ammonia containing mixture has a shorter shelf-life and will separate in a few weeks. The separation time is dependant on the amount of fatty-acid containing material in the mixture. A lower level of fatty-acid containing material will show signs of separation earlier than higher levels. The relatively long shelf life of the product is an advantage over prior mixtures. Even after separation, movement in a tank truck is enough to remix the product. As indicated, the components of the composition of the invention may be loaded into a tank truck and movement of the truck to a spray site is sufficient to mix the product. Except in sub-freezing ambient temperatures, the truck does not need to be insulated and additional heating or mixing of the composition for spraying is unnecessary.

The amount of the composition applied to the surface, i.e., the rate of application, is not critical, but does affect the time needed for the material to be absorbed into the surface and to dry. The more heavily applied, the harder and more durable the surface appears to be, but the longer it takes to be absorbed and dry. However, it has been found that an application rate of between about 25 to about 45 square feet per gallon, and preferably about 25 to about 35 square feet per gallon creates a satisfactory and long lasting surface. The amount of fatty acid containing material in the composition also affects the absorption and drying time. However, it has been found that the composition containing sodium hydroxide or ammonia is more easily absorbed into the earth surface when applied to the surface than my previous formulations which, when used on a road surface, allows traffic to return to the road faster than previously, generally within an hour or so.

It has also been found that the absorption rate of the composition of the invention into the surface being treated can be increased by breaking up the top about one inch of the surface prior to application of the composition and by then rolling the surface after application of the composition. A harrow type device can be used to break up the top surface, and advantageously, such a device can be mounted on a tank truck ahead of the spray bar to break up the surface immediately prior to the application of the composition through the spray bar. The truck is then followed by a roller to roll and compact the surface. With this procedure, the composition does not need time to soak into the surface being treated since it is dispersed into the surface by the breaking up of the surface and spraying of the broken up surface, followed by the rolling. This procedure shortens the time to get traffic back on the surface to about one hour and may increase the life of the surface.

### EXAMPLE 1

Approximately 2000 square feet of dirt road (20 feet by 100 feet) and approximately 2500 square feet of dirt road (25 feet by 100 feet) were treated with the composition of the invention consisting of 35% used vegetable oil, the balance being water mixed with a small amount of sodium hydroxide (about 0.5% by weight of the finished composition). The composition was applied to the surface of the dirt road using a hand sprayer. The ambient temperature was about 55° F. The surface was then observed and appeared to harden and not only controlled dust, but also became water resistant. It rained the night after application of the composition without any adverse affect on the surface.

### EXAMPLE 2

Approximately 56,136 square feet of dirt road 24 feet wide was treated with the composition of the invention consisting of 40% yellow grease, the balance being water mixed with a small amount of sodium hydroxide (about 0.37% by weight of the finished composition). The yellow grease was at a temperature of about 100° F. and the water-sodium hydroxide solution was at a temperature of about 70° F. when the two were mixed. After mixing, the product was at a temperature of about 75° F. and was at about that same temperature when applied to the road surface by a spray truck. The composition was applied to the surface of the dirt road at the rate of about twenty five square feet per gallon. The ambient temperature was about 95° F. The road was used for construction equipment building a housing development. Traffic was back on the road within three to four hours of application of the product. The surface hardened and not only controlled dust, but also became water resistant.

### EXAMPLE 3

Approximately 46,248 square feet of dirt road (12 feet by about three quarter mile) was treated with the composition of the invention consisting of 40% yellow grease, the balance being water mixed with a small amount of sodium hydroxide (about 0.375% by weight of the finished composition). The yellow grease was at a temperature of about 100° F. and the water-sodium hydroxide solution was at a temperature of about 70° F. when the two were mixed. After mixing, the product was at a temperature of about 75° F. and was at about that same temperature when applied to the road surface by a spray truck. The composition was applied to the surface of the dirt road at the rate of about twenty five square feet per gallon. The ambient temperature was about 95° F. The road was a city dirt road used for city traffic. Traffic was back on the road within three to four hours of application of the product. The surface hardened and not only controlled dust, but also became water resistant. After about seven months and several rains, the road surface is still as it was initially after application of the composition.

### EXAMPLE 4

Approximately 31,680 square feet of dirt road (12 feet by one half mile), approximately 15,840 square feet of dirt road (12 feet by one quarter mile), and approximately 31,680 square feet of dirt road (12 feet by one half mile) were treated with the composition of the invention consisting of 50% yellow grease, the balance being water mixed with a small amount of sodium hydroxide (about 0.375% by weight of the finished composition). The composition was applied to the surface of the dirt road by a spray truck. The ambient temperature was about 110° F. Traffic was kept off the road for about three hours in the case of the quarter mile section and for eighteen to twenty four hours in the case of the half mile sections. The surface hardened and not only controlled dust, but also became water resistant.

### EXAMPLE 5

Approximately 15,840 square feet of road (12 feet by one quarter mile), was treated with the composition of the invention consisting of 50% yellow grease, the balance being water mixed with a small amount of sodium hydroxide (about 0.375% by weight of the finished composition). The road was an asphalt road where the asphalt had been pulled up, crushed to a smaller size, and the crushed recycled asphalt put down on the road surface as road base. The composition was applied to this recycled asphalt road base material by a spray truck. The ambient temperature was about 110° F. Traffic was kept off the road for about five hours. The surface hardened and not only controlled dust, but also became water resistant.

Whereas this invention is here described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

1. A method of a controlling dust from or erosion of earth surfaces comprising the steps of mixing water, a mixing aid selected from the group consisting of sodium hydroxide or ammonia, and a fatty acid containing material selected from the group consisting of rendered grease from animals, used vegetable oil, or a mixture thereof to produce a dust control composition; and applying the dust control composition to the earth surface to be absorbed into the earth surface.

2. A method for controlling dust from or erosion of earth surfaces according to claim 1, wherein the fatty acid containing material is selected from the group consisting of yellow grease or tallow.

3. A method of controlling dust from and erosion of earth surfaces according to claim 1, wherein the composition is applied to an earth surface by spraying and the spray temperature of the composition is at least about 40° F.

4. A method of controlling dust from and erosion of earth surfaces according to claim 1, wherein the fatty acid containing material is heated to a temperature above its fudge point before being mixed with the water and mixing aid.

5. A method of controlling dust from and erosion of earth surfaces according to claim 1, wherein the mixing aid is a fifty-fifty mixture of sodium hydroxide and water and makes up between about 0.75% and about 1% of the composition by weight.

6. A method of controlling dust from or erosion of earth surfaces according to claim 5, wherein the fatty acid containing material makes up between about 5% and about 95% of the composition by weight.

7. A method of controlling dust from and erosion of earth surfaces according to claim 1, wherein the mixing aid is a 5% aqueous ammonia solution and makes up at least about 4% of the composition by weight.

8. A method of controlling dust from or erosion of earth surfaces according to claim 7, wherein the fatty acid containing material makes up between about 5% and about 95% of the composition by weight.

9. A method of controlling dust from and erosion of earth surfaces according to claim 7, wherein the ammonia solution and makes up at least about 5% of the composition by weight.

10. A method of controlling dust from and erosion of earth surfaces according to claim 1, wherein the composition is applied to the earth surface at an application rate of between about 25 to about 45 square feet per gallon.

11. A method of controlling dust from and erosion of earth surfaces according to claim 10, wherein the composition is applied to the earth surface at an application rate of between about 25 to about 35 square feet per gallon.

12. A liquid treatment composition for earth surfaces to control dust from and erosion of the earth surface to which the product is applied, comprising:
a fatty acid containing material selected from the group consisting of rendered grease from animals, used vegetable oil, or a mixture thereof;
water; and
a mixing aid selected from the group consisting of sodium hydroxide or ammonia.

13. A liquid treatment composition for earth surfaces to control dust from or erosion of the earth surface to which the product is applied according to claim 12, wherein the fatty acid containing material is selected from the group consisting of yellow grease or tallow.

14. A liquid treatment composition for earth surfaces to control dust from and erosion of the earth surface to which the product is applied according to claim 12, wherein the fatty acid containing material makes up between about 5% and about 95% of the composition, the sodium hydroxide about 1%, and the water is the remaining balance.

15. A liquid treatment composition for earth surfaces to control dust from and erosion of the earth surface to which the product is applied according to claim 12, wherein the mixing aid is a fifty-fifty mixture of sodium hydroxide and water and makes up between about 0.75% and about 1% of the composition by weight.

16. A liquid treatment composition for earth surfaces to control dust from and erosion of the earth surface to which the product is applied according to claim 12, wherein the mixing aid is a 5% aqueous ammonia solution and makes up at least about 4% of the composition by weight.

17. A liquid treatment composition for earth surfaces to control dust from and erosion of the earth surface to which the product is applied according to claim 16, wherein the mixing aid is a 5% aqueous ammonia solution and makes up at least about 5% of the composition by weight.
